(19) United States
(12) Patent Application Publication
(10) Pub. No.: US 2020/0243821 A1
(43) Pub. Date: Jul. 30, 2020

(54) BATTERY HAVING A FLAT TOP COVER CONFIGURATION INCLUDING CENTERLINE BATTERY CELL VENTS, A CENTERLINE HANDLE CONFIGURED TO COLLAPSE TO A RECESSED STATE AND TO WRAP AROUND TERMINALS, AND SIDE FLAME ARRESTOR VENT

(71) Applicant: Exide Technologies, Milton, GA (US)

(72) Inventors: Travis Zachary Torrey, Cumming, GA (US); Brian Westbrook, Marietta, GA (US); Thomas Bruce Montgomery, Elizabethtown, PA (US); Fred F. Feres, Sarasota, FL (US); Steve Peterson, Minneapolis, MN (US)

(21) Appl. No.: 16/260,295

(22) Filed: Jan. 29, 2019

(51) Int. Cl. H01M 2/12; H01M 2/04; H01M 2/30; H01M 10/06

(52) U.S. Cl. CPC H01M 2/127; H01M 2/1217; H01M 10/06; H01M 2/305; H01M 2/043

(57) ABSTRACT

A battery having a flat top configuration is described including a handle attached across the centerline, the handle configured to be recessed relative to the periphery of the primary cover and to wrap around the terminals in a collapsed state, wherein the cover includes centerline battery cell vents and at least one side flame arrestor vent.

### TECHNICAL FIELD

The present invention is generally related to batteries, including lead-acid batteries, motive power batteries, hybrid battery systems, etc., for various industries, including but not limited to automotive and industrial battery systems. More particularly, example embodiments of the present invention are directed to a battery having a flat top cover configuration including a handle attached across the centerline, the handle configured to be recessed relative to the periphery of the primary cover and to wrap around the terminals in a collapsed state, wherein the cover includes centerline battery cell vents and at least one side flame arrestor vent.

### BACKGROUND OF THE INVENTION

Traditional batteries using suitcase handle systems require significant space in order to form the pin attachment in the molding process. Thus, the required space in a traditional suitcase handle design prevents the battery's vent holes from aligning to the centerline of the battery. The most optimal location of a battery vent is along the centerline. More specifically, the breach point of the venting system, or the area where the vent chamber crosses with the lower battery main chamber, finds advantage being aligned to the centerline. If the vents are located off the centerline, the battery is more susceptible to leaking during battery tilt.

Accordingly, prior batteries utilize a strap handle, rather than a suitcase handle, that connects to the battery container. However, this type of handle is poorly viewed in the marketplace and has a tendency to create fitment issues. It is often removed and is lost by the user. An inset suitcase handle is generally preferred, both from a visual aspect and from a practical aspect, as being a more capable handle system; however the lack of the ability to use the inset suitcase handle with the centerline vent system to optimize a battery's leak prevention characteristics, has resulted in problems in the marketplace.

Exemplary areas of improvement involve problems in the art related to handle breakage while lifting batteries, as well as to significant battery cover or handle cracking or deformation subsequent to exposure to securing forces of a top hold down system. Other exemplary areas of improvement involve problems in the art related to electrolyte retention in inter-cell partitions by capillary action, spewing of electrolyte, hydraulic pumping with electrolyte rise during severe gassing while charging, and water ingestion. Additional concerns and areas for improvement in battery design relate to the need to keep flame arrestor vents remote from battery terminals to reduce the likelihood of sparking.

### BRIEF SUMMARY OF THE INVENTION

According to an example embodiment of the present invention, a battery having a flat top cover configuration is described, including a battery container including plural battery cells, a battery cover sealed to the battery container, the primary cover including plural battery cell openings along a centerline of the battery, plural battery terminals operatively connected to said plural battery cells and extending through the battery cover on a first side of the battery centerline, a handle having a centerline attachment to the primary cover, the handle configured to be recessed with regard to the periphery of the battery cover and to wrap around the terminals in in a collapsed state on the first side of the battery centerline, and at least one side vent communicating internal flame arrestor material with atmosphere, the at least one side vent positioned on a second side, opposite side of the battery centerline.

Further exemplary embodiments provide a battery having a flat top cover configuration is provided including: a battery container including plural battery cells, the battery having a flat top cover configuration, a primary battery cover sealed to the battery container, plural terminals operatively connected to said plural battery cells and extending through the primary cover, and a handle having a centerline attachment to the primary cover, the handle configured to be recessed with regard to the periphery of the primary cover and to wrap around the terminals in in a collapsed state. A secondary cover is provided opposite the centerline from the terminals and sealed to the primary cover, the secondary cover including at least one side vent communicating internal flame arrestor material with atmosphere. In exemplary embodiments, the primary and secondary covers cooperate to define battery cell vents along the centerline of the battery.

In additional exemplary embodiments, the handle includes an inset portion having an inwardly curved section between said terminals and having two assembly apertures on opposing sides of the primary battery cover outside of the inwardly curved section, the inset portion being recessed in a flush manner with the primary cover around the terminals. In further exemplary embodiments, the handle is a full periphery, suitcase handle having an curved section in a middle portion thereof and having two assembly pins on opposing sides of the handle outside of the curved section, the curved section providing an ergonomic handle contour in an upright state relative to the first cover and a flat profile in a folded, inset state relative to the first cover.

Further exemplary embodiments describe a handle that includes internal diagonal cross ribbing between the curved, ergonomic portion of the handle and the opposing, flat portion of the handle along the edge of the first cover adjacent the curved portion.

In additional exemplary embodiments the primary cover further comprises plural cell openings, each of said plural cell openings including a raised wall portion having an upper circumferential wall opening in communication with a cell electrolyte overflow area that is defined by upstanding walls; the secondary battery cover sealed to the primary battery cover, the secondary battery cover including: plural hollow posts configured to extend from a bottom portion thereof, within the cell openings of the primary battery cover, the top portion thereof being open to the hollow openings of the posts; plural gas flow areas complementary to the configuration of the cell electrolyte overflow area of the primary battery cover and including wall channels to permit gasses to flow between such defined gas flow areas; and at least one frit disposed between and in communication with said gas flow areas and an outside vent in the secondary battery cover.

Additional exemplary embodiments describe an anti-spewing baffle and alignment guide for the secondary cover as hollow posts provided at least partially within cell openings.

Additional features and advantages are realized through the system of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views. Furthermore, each drawing contained in this provisional application includes at least a brief description thereon and associated text labels further describing associated details. The figures:

FIG. 1 is a perspective view of an exemplary battery system including a flat top configuration, according to example embodiments;

FIG. 2 is a top perspective view of an exemplary handle, according to example embodiments;

FIG. 3 is a bottom perspective view of an exemplary handle, according to example embodiments;

FIG. 4 is a top perspective view of an exemplary primary cover, according to example embodiments;

FIG. 5 is a bottom perspective view of an exemplary primary cover, according to example embodiments;

FIG. 6 is a top perspective view of an exemplary secondary cover, according to example embodiments; and

FIG. 7 is a bottom perspective view of an exemplary secondary cover, according to example embodiments.

### DETAILED DESCRIPTION OF THE INVENTION

Further to the brief description provided above and associated textual detail of each of the figures, the following description provides additional details of example embodiments of the present invention.

Detailed illustrative embodiments are disclosed herein. However, specific functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments.

It will be understood that, although the terms first, second, etc. may be used herein to describe various steps or calculations, these steps or calculations should not be limited by these terms. These terms are only used to distinguish one step or calculation from another. For example, a first calculation could be termed a second calculation, and, similarly, a second step could be termed a first step, without departing from the scope of this disclosure. As used herein, the term “and/or” and the “/ ” symbol includes any and all combinations of one or more of the associated listed items.

As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting of example embodiments.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Hereinafter, example embodiments of the present invention will be described in detail. Example embodiments of the present invention provide a battery system having a flat top cover configuration with centralized venting and a flush suitcase handle.

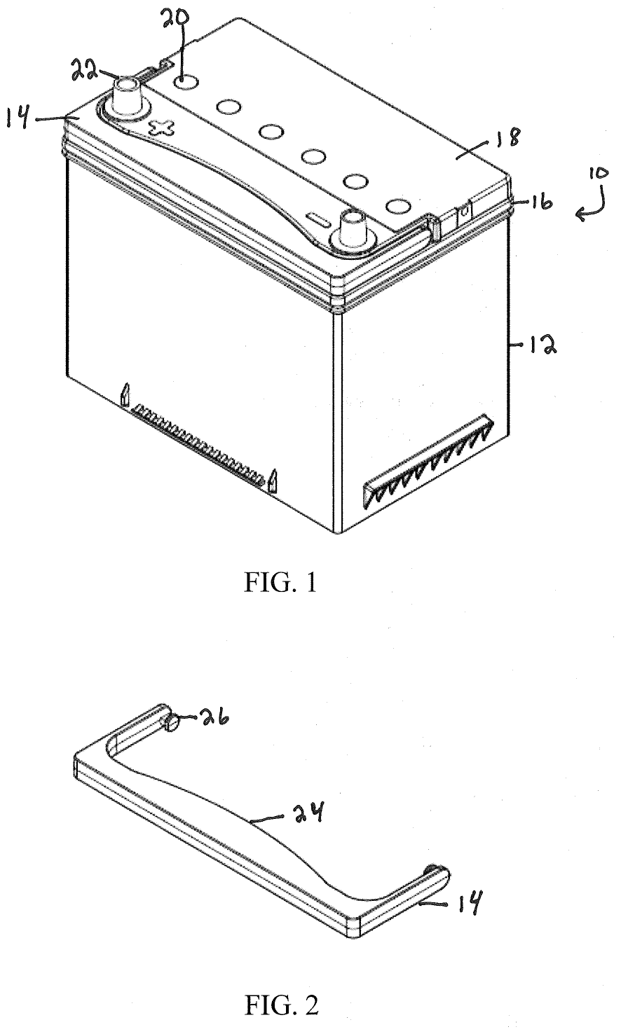

FIG. 1 illustrates an exemplary battery system in accordance with the present disclosure generally at 10. It should be noted that while the figures generally depict a lead-acid battery, the present disclosure is not limited thereto, but applies equally to other battery types, such as motive power systems and hybrid battery systems, where some or all of the aspects described herein may be advantageous.

Referring again to FIG. 1, the illustrated exemplary battery system 10 includes a container 12 (containing one or more battery cells, not shown), a handle 14, a primary cover 16, a secondary (manifold) cover 18, plural vents 20, and terminals 22 (positive and negative). Various aspects of the battery system shown in FIG. 1 will be further described with reference to the additional following figures:

Referring specifically to FIG. 2, an exemplary battery handle 14 is illustrated in perspective, showing an ergonomic, rounded handle portion 24 and handle connection pin 26, the entire handle (when viewed in the context of FIG. 1) providing a full peripheral, flush/inset suitcase handle that wraps around the battery terminals and allows for a venting system along the battery centerline. One exemplary suitcase type handle is described by commonly owned U.S. Pat. No. 6,022,638 to Horton et al., the entire contents of which are incorporated herein by reference, which describes a lead-acid battery having a handle utilizing a pin-and-button structure connection in a self-latching configuration.

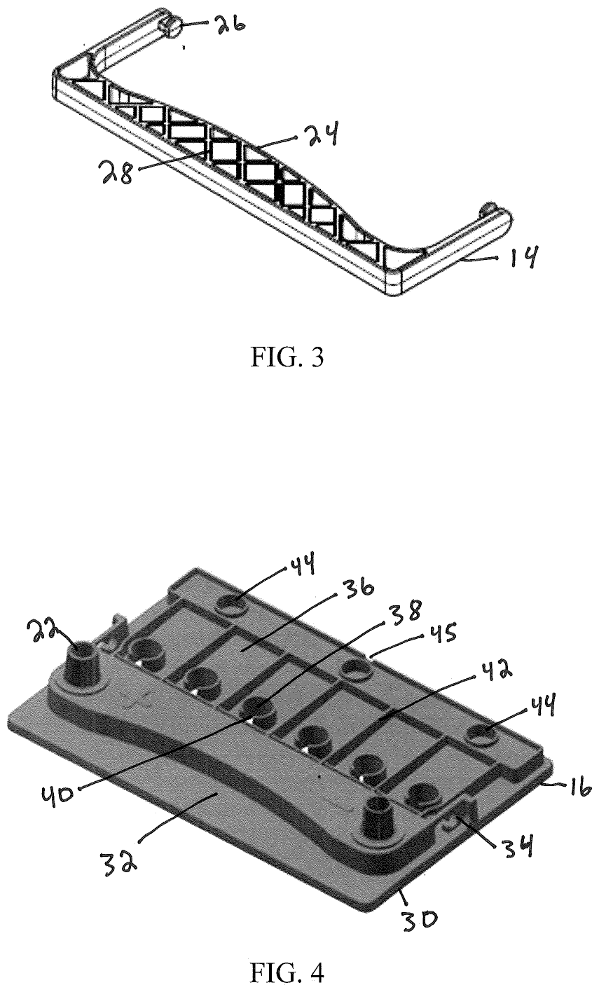

FIG. 3 illustrates an exemplary bottom perspective view of the handle 14, showing the ergonomic rounded handle portion 24 and the handle connection pin 26, as well as a reinforcing structure 28, configured as an internal diagonal cross ribbing provided between the ergonomic rounded portion and the opposing flat periphery of the handle.

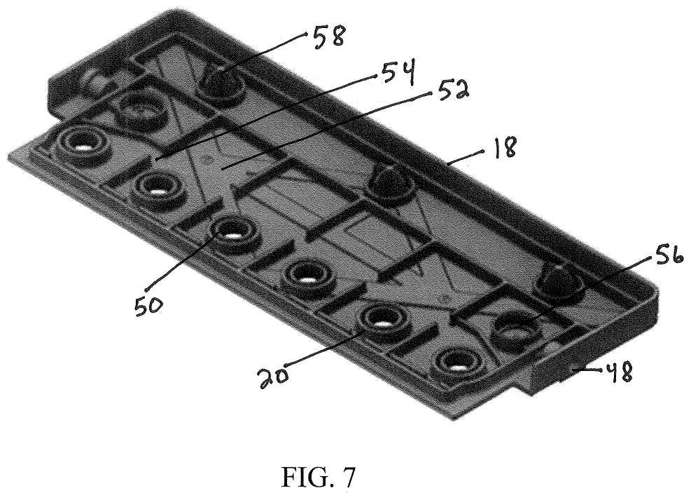

FIG. 4 illustrates an exemplary top perspective view of a primary cover 16, illustrating the terminals 22 (e.g., lead posts), cell openings 38 having at least one gap 40 at an upper circumferential portion, each provided within an exemplary rectangular area 36 defined by upstanding walls 42 (which in exemplary embodiments are the same height or rise to the same height relative to the bottom of the battery), alignment members 44 (see complementary male alignment members below in FIG. 7, item 58) also illustrated with a vacuum break 45 for heat sealing of the cover. FIG. 4 also illustrates a handle recess area 32 configured to accept the handle, including handle assembly aperture 34, and lower sealing edge 30.

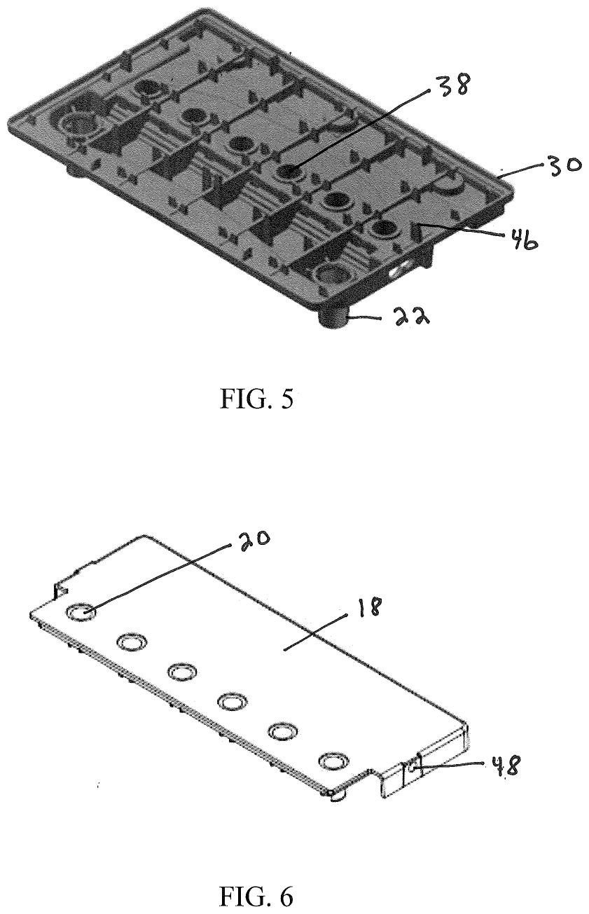

FIG. 5 illustrates an exemplary bottom perspective of the primary cover 16, showing lower portions of the terminals 22, the lower sealing edge 30, lower portions of the cell openings 30 and structural reinforcing and alignment protrusions 46. During assembly, the primary cover is sealed to the battery container around the sealing edge 30, e.g., by heat sealing, ultrasonic welding, etc.). Subsequently, the secondary (manifold) cover 18, which will be described in more detail below, is installed over and sealed to (e.g., heat sealing, ultrasonic welding, etc.) the primary cover.

FIG. 6 illustrates an exemplary top perspective of the secondary cover 18, illustrating plural vents 20 and frit opening 48. We note that exemplary embodiments refer to primary and secondary covers as separate entities, though the present disclosure does note regard these separate pieces as a requirement. Indeed, (noting that there are certain manufacturing advantages relative to the dual cover design described in certain exemplary embodiments described herein) a single primary cover could include, on one side terminal post holes and a recessed handle space, and on a side opposite the centerline, one or plural side vents communicating with flame arrestor(s). Further, we should note that the term “centerline” is not meant to only include the exact axis that is a center of mass of the battery, but instead includes positioning that is close, but not exactly on that axis (the intent being to reduce tilt of the battery during usage of the handle).

FIG. 7 illustrates an exemplary bottom perspective of the secondary cover 18, showing vents 20 having exemplary hollow posts 50 that extend at least partially down into the cell openings 38. The underside of the secondary cover 18, in similar fashion to the top of the primary cover 16, defines exemplary rectangular areas having walls, with the exception that the underside of the secondary cover 18 includes channel breaks 54 in the continuity of the area-defining walls, providing upper vent passages for gasses from the vents to the fits 56 and associated frit opening 48. The secondary cover 18 also illustrates exemplary male alignment members 58 complementary to the alignment members 44 in FIG. 4.

As we have noted above, the present battery system presents a battery having a flat top cover configuration, including a battery container including plural battery cells, a battery cover sealed to the battery container, the primary cover including plural battery cell openings along a centerline of the battery, plural battery terminals operatively connected to said plural battery cells and extending through the battery cover on a first side of the battery centerline, a handle having a centerline attachment to the primary cover, the handle configured to be recessed with regard to the periphery of the battery cover and to wrap around the terminals in in a collapsed state on the first side of the battery centerline, and at least one side vent communicating internal flame arrestor material with atmosphere, the at least one side vent positioned on a second side, opposite side of the battery centerline.

Exemplary embodiments blend the advantages of a centralized battery cell venting configuration and a full peripheral, flush/inset suitcase handle that wraps around the battery terminals, while also allowing for a flame arrestor venting system along the battery cover side.

In further exemplary embodiments, the battery system presents a flat top cover configuration including a primary battery cover sealed to the battery container, plural terminals operatively connected to said plural battery cells and extending through the primary cover, and a handle having a centerline attachment to the primary cover, the handle configured to be recessed with regard to the periphery of the primary cover and to wrap around the terminals in in a collapsed state. A secondary cover is provided opposite the centerline from the terminals and sealed to the primary cover, the secondary cover including at least one side vent communicating internal flame arrestor material with atmosphere. In exemplary embodiments, the primary and secondary covers cooperate to define battery cell vents along the centerline of the battery.

By configuring the collapsible handle around the terminals, this configuration allows for collapsibility and disposition across the battery centerline, while also allowing for remote (relative to the terminals) side vents for flame arrestors.

In additional exemplary embodiments, the handle includes an inset portion having an inwardly curved section between said terminals and having two assembly apertures on opposing sides of the primary battery cover outside of the inwardly curved section, the inset portion being recessed in a flush manner with the primary cover around the terminals. In further exemplary embodiments, the handle is a full periphery, suitcase handle having an curved section in a middle portion thereof and having two assembly pins on opposing sides of the handle outside of the curved section, the curved section providing an ergonomic handle contour in an upright state relative to the first cover and a flat profile in a folded, inset state relative to the first cover.

Further exemplary embodiments describe a handle that includes internal diagonal cross ribbing between the curved, ergonomic portion of the handle and the opposing, flat portion of the handle along the edge of the first cover adjacent the curved portion, which provides maximum resistance to deformation while providing robustness under load.

Further exemplary embodiments describe a full peripheral design handle with, in some embodiments, a rounded, ergonomic hand contour that provides for easy and safe lifting, but that is also secure enough to accept the load forces applied by a battery hold down bracket (e.g., a J-bolt type or full frame bracket) when the handle is down, thus preventing cracking or deformation of the handle system. Also, as is noted above, the primary cover may be contoured in complementary fashion (see 32 in FIG. 4), resulting in a cover that is less prone to lateral deformation under load.

With regard to the manifold cover configuration, exemplary embodiments provide the principal primary cover (16) with a pre-sealed secondary cover (18) having cell openings for the introduction of electrolyte prior to the formation process, with cell openings being sealed by ultrasonic or pressure fitted plugs after the battery formation process is completed. Examples of suitable plugs include plugs with smooth wall contacts, having an inner diameter interference of between about 0.008 to 0.01 inches. Exemplary embodiments utilizing sonic sealing of plugs additionally include an energy director ring.

In additional exemplary embodiments the primary cover further comprises plural cell openings, each of said plural cell openings including a raised wall portion having an upper circumferential wall opening in communication with a cell electrolyte overflow area that is defined by upstanding walls; the secondary battery cover sealed to the primary battery cover, the secondary battery cover including: plural hollow posts configured to extend from a bottom portion thereof, within the cell openings of the primary battery cover, the top portion thereof being open to the hollow openings of the posts; plural gas flow areas complementary to the configuration of the cell electrolyte overflow area of the primary battery cover and including wall channels to permit gasses to flow between such defined gas flow areas; and at least one frit disposed between and in communication with said gas flow areas and an outside vent in the secondary battery cover.

Additional exemplary embodiments describe an anti-spewing baffle and alignment guide for the secondary cover as hollow posts extending at least partially within cell openings.

With further regard to flame arrestor frits (see 56 in FIG. 4), suitable frit designs and materials include those discussed in commonly owned U.S. Pat. No. 6,110,617 to Feres, the entire contents of which are incorporated herein by reference. In particular, the frit material may be of any convenient shape, though exemplary discs are illustrated and described. The frits may be traditional glass or polypropylene fit material, the porous, hydrophobic polytetrafluoroethylene (PTFE) material, TEFLON ® material, or any other suitable material.

Further, the illustrated exemplary embodiments provide a manifold that avoids closely-spaced inter-cell partitions, which prevents electrolyte retention by capillary action while trapping any fluids that may attempt to migrate from cell to cell or to reach the frit area, which would otherwise cause fluid loss during vibration, motion or tilting.

It should be emphasized that the above-described embodiments of the present invention, particularly, any detailed discussion of particular examples, are merely possible examples of implementations, and are set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

What is claimed is:

1. A battery having a flat top cover configuration, comprising:
a battery container including plural battery cells;
a battery cover sealed to the battery container, the primary cover including plural battery cell openings along a centerline of the battery;
plural battery terminals operatively connected to said plural battery cells and extending through the battery cover on a first side of the battery centerline;
a handle having a centerline attachment to the primary cover, the handle configured to be recessed with regard to the periphery of the battery cover and to wrap around the terminals in in a collapsed state on the first side of the battery centerline; and
at least one side vent communicating internal flame arrestor material with atmosphere, the at least one side vent positioned on a second side, opposite side of the battery centerline.

2. A battery in accordance with claim 1, wherein said battery cover includes:
a primary battery cover sealed to the battery container, plural terminals operatively connected to said plural battery cells and extending through the primary cover, the handle having a centerline attachment to the primary cover, the handle configured to be recessed with regard to the periphery of the primary cover and to wrap around the terminals in in a collapsed state; and
a secondary cover having at least a portion provided opposite the centerline from the terminals and sealed to the primary cover, the secondary cover including at least one side vent communicating internal flame arrestor material with atmosphere, wherein the primary and secondary covers cooperate to define battery cell vents along the centerline of the battery.

3. A battery in accordance with claim 2,
wherein the primary cover further comprises:
plural cell openings, each of said plural cell openings including a raised wall portion having an upper circumferential wall opening in communication with a cell electrolyte overflow area that is defined by upstanding walls; and
wherein the secondary battery cover further comprises:
plural hollow posts configured to extend from a bottom portion thereof and at least partially within the cell openings of the primary battery cover, the top portion thereof being open to the hollow openings of the posts;
plural gas flow areas complementary to the configuration of the cell electrolyte overflow area of the primary battery cover and including wall channels to permit gasses to flow between such defined gas flow areas; and
at least one frit disposed between and in communication with said gas flow areas and an outside vent in the secondary battery cover.

4. A battery in accordance with claim 1, wherein the handle comprises a full periphery, suitcase handle having an curved section in a middle portion thereof and having two assembly pins on opposing sides of the handle outside of the curved section, the curved section providing an ergonomic handle contour in an upright state relative to the battery cover and a flat profile in a folded, inset state relative to the battery cover.

5. A battery in accordance with claim 4, wherein the curved section is an inwardly curved section between said terminals and wherein the battery cover has a complementary curved profile configured to receive the handle in a collapsed state.

6. A battery in accordance with claim 4, wherein said handle includes internal diagonal cross ribbing between the curved, ergonomic portion of the handle and the opposing, flat portion of the handle along the edge of the first cover adjacent the curved portion.

7. A battery in accordance with claim 3, wherein said hollow posts of said secondary cover are configured to act as an anti-spewing baffle as well as an alignment guide for the secondary cover.

8. A battery in accordance with claim 2, wherein at least one of said first and second covers includes alignment guides.
